(19) United States
(12) Patent Application Publication
(10) Pub. No.: US 2018/0059227 A1
(43) Pub. Date: Mar. 1, 2018

(54) SYSTEM AND METHOD FOR TESTING MOTION SENSOR

(71) Applicant: LITE-ON SINGAPORE PTE. LTD., MIDVIEW CITY (SG)

(72) Inventors: SOON-LEE TAN, SINGAPORE (SG); FEI WANG, SINGAPORE (SG); CHEE-WEN LEE, SINGAPORE (SG); ARAKCRE DINESH GOPALASWAMY, BANGALORE (IN)

(21) Appl. No.: 15/377,930

(22) Filed: Dec. 13, 2016

(30) Foreign Application Priority Data
Aug. 31, 2016 (CN) 201610797264.3

(51) Int. Cl. G01S 7/497

(52) U.S. Cl. CPC G01S 7/497

(57) ABSTRACT

The instant disclosure provides a system and method for testing a motion sensor. The motion sensor includes a light-emitting unit and an optical sensing unit. The system includes a detection beam generation module, a control module and a processor module. The detection beam generation module is disposed above the motion sensor for intermittently projecting a detection beam onto the optical sensing unit. The control module is electrically connected to the detection beam generation module for controlling the schedule of the testing light. The processor module is electrically connected to the optical sensing unit for generating a testing result according to the detection beam received by the optical sensing unit.

### BACKGROUND

### 1. Technical Field

The instant disclosure relates to a system and a method for testing a sensor, in particular, to a system and a method for testing a motion sensor.

### 2. Description of Related Art

Motion sensors (MS, or referred to as gesture sensor, GS) including infrared light-emitting diodes (IR LEDs) are widely used in portable electronic devices and wearable electronic devices such as smart phones, tablets, audio speakers, headphones or smart watches for providing touchless control applications. In addition, existing 3 in 1 testers are used for testing ambient light sensors (ALS), proximity sensors and motion sensors on the production line. To be specific, a gray card having a reflective index of 18% is moved along east-west direction and south-north direction above the motion sensor to reflect the light emitted by the light-emitting unit of the motion sensor to the optical sensor unit of the motion sensor, thereby obtaining a detection signal. A processor electrically connected to the motion sensor can perform data calculation and processing according to the detection signals received when the grey card is located at different locations above the motion sensor.

Please refer to FIG. 1. FIG. 1 is a schematic view of a detection device 1 for testing a motion sensor in an existing 3 in 1 tester. To be specific, the testing procedure using the existing detection device 1 at least comprises the following steps: (a) directly disposing a grey card 11 with a reflective index of 18% at a fixed position above the motion sensor 10 at 2 to 5 centimeters and projecting a light beam toward the grey card 11 by driving the light-emitting unit 101 of the motion sensor 10 through the control module 12, and the light beam is reflected by the grey card 11 and projects onto the optical sensor unit 102 of the motion sensor 10 for obtaining an initial detection signal; (b) moving the grey card 11 along the following directions respectively: from east to west, from west to east, from south to north and from north to south, and storing the detection signals reflected by the grey card 11 and received by the optical sensor unit 10 under different timing in a storage unit (not shown); and (c) calculating the initial detection signal and the detection signals by a processor 14 to obtain an detection result.

The 3 in 1 tester utilizing the grey card 11 has the advantage of stimulating the sensing mode in actual use. However, the disadvantage of such a procedure comprises the increased structural complexity and manufacturing cost resulting from the use of a driving device 13 (such as an auto-handler) for driving the grey card 11. In addition, the movement of the grey card 11 increases the time for completing the testing procedure. For example, the time for completing the testing procedure is about 9 to 10 seconds.

Therefore, there is a need to provide a system and method for testing a motion sensor for solving the disadvantages related to the existing 3 in 1 tester.

### SUMMARY

In order to solve the above technical problems, the instant disclosure provides a motion sensor testing system and a method for testing a motion sensor.

The system and method for testing a motion sensor provided by the instant disclosure employ a detection light beam generation module disposed at a fixed location to perform the function of the light-emitting unit of the motion sensor and the grey card in the existing art. Specifically, compared to the existing art which utilizes the light-emitting unit of the motion sensor to project a light beam onto the grey card and reflecting the light beam onto the optical sensor unit of the motion sensor by the grey card, the instant disclosure employs the detection beam generation module to stimulate the light beams emitted from different directions, thereby achieving the effect of testing the motion sensor.

Since the system and method for testing a motion sensor provided by the instant disclosure employs a detection beam generation module, the structural complexity and manufacturing cost of the motion sensor testing system can be significantly reduced. In addition, since the procedure of moving the grey card back and forth is eliminated, the operation procedure of the system and method for testing the motion sensor provided by the instant disclosure is simple and the testing time is short. Moreover, since the device for testing the ambient light sensor in the existing 3 in 1 tester comprises a light source plate, the detection beam generation module of the instant disclosure can be integrated to the light source plate to further reduce the cost for manufacturing and maintaining the tester.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a schematic view of a detection device for testing a motion sensor in an existing 3 in 1 tester.

FIG. 2 is a schematic view of the motion sensor testing system and the motion sensor of the embodiment of the instant disclosure.

FIG. 3 is a bottom view of the detection beam generation module of the motion sensor testing system provided by the embodiment of the instant disclosure.

FIG. 4 is a sectional view of the detection beam generation module of the motion sensor testing system and the motion sensor provided by the embodiment of the instant disclosure under a first timing.

FIG. 5 is a sectional view of the detection beam generation module of the motion sensor testing system and the motion sensor provided by the embodiment of the instant disclosure under a second timing.

FIG. 6 is a sectional view of the detection beam generation module of the motion sensor testing system and the motion sensor provided by the embodiment of the instant disclosure under a third timing.

FIG. 7 a sectional view of the detection beam generation module of the motion sensor testing system and the motion sensor provided by the embodiment of the instant disclosure under a fourth timing.

FIG. 8 is a flow chart of the method for testing a motion sensor provided by the embodiment of the instant disclosure.

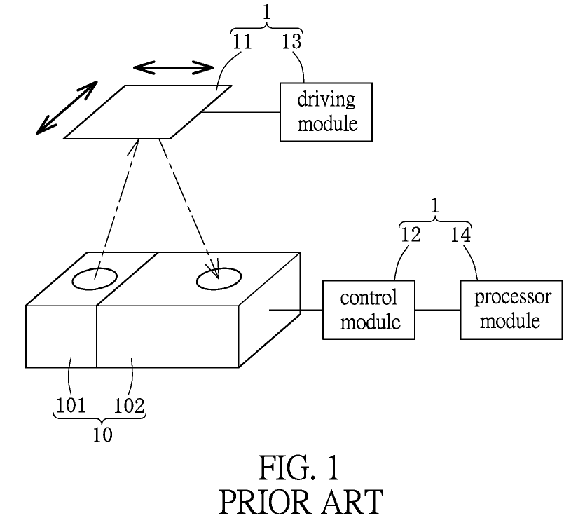

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

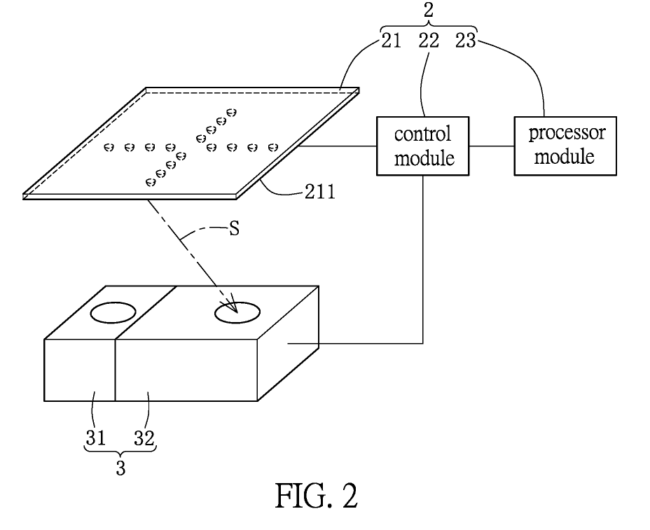

Please refer to FIG. 2. FIG. 2 is a schematic view of the motion sensor testing system and the motion sensor of the embodiment of the instant disclosure. The motion sensor testing system 2 is used for testing the motion sensor 3 comprising a light emission unit 31 and an optical sensing unit 32. The motion sensor 3 generally comprises a single infrared light—emitting diode as the light emission unit 31 and the optical sensing unit 32 comprises four directional detectors integrated into an integrated chip (IC). The four directional detectors are diodes for testing the motion toward east, west, south and north respectively.

As shown in FIG. 2, the motion sensor testing system 2 provided by the instant disclosure comprises a detection beam generating module 21, a control module 22 and a processor module 23. The detection beam generating module 21 is disposed above the motion sensor 3. In the embodiments of the instant disclosure, the detection beam generating module 21 has a light emission surface 211, and the light emission surface 211 is facing toward the optical sensing unit 32 of the motion sensor 3 to intermittently project a detection beam S to the optical sensing unit 32. The distance between the light emission surface 211 and the optical sensing unit 32 can be 8-10 centimeters. However, the instant disclosure is not limited thereto.

The control module 22 is electrically connected to the detection beam generating module 21 for controlling the schedule of the detection beam generating module 21 to intermittently project the detection beam S onto the optical sensing unit 32. As shown in FIG. 2, the control module 22 is also electrically connected to the optical sensing unit 32 of the motion sensor 3. The processor module 23 is electrically connected to the optical sensing unit 32, in which the processor module 23 generates a detecting result according to the detection beam S received by the optical sensing unit 32. In the embodiment shown in FIG. 2, the processor module 23 is electrically connected to the optical sensing unit 32 through the control module 22.

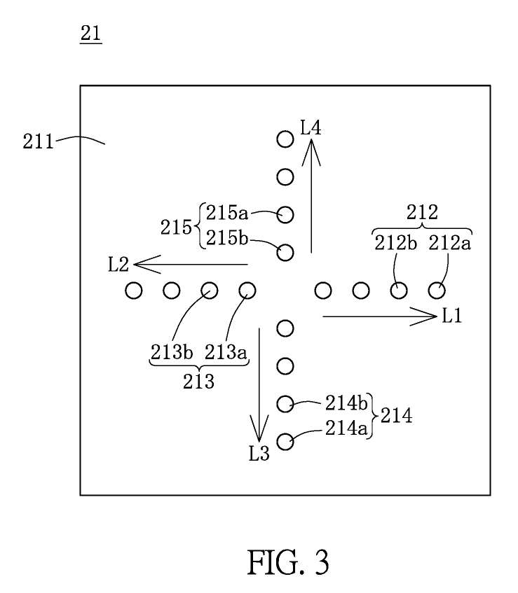

Next, please refer to FIG. 3. FIG. 3 is a bottom view of the detection beam generation module of the motion sensor testing system provided by the embodiment of the instant disclosure. In the embodiments of the instant disclosure, the light emission surface 211 of the detection beam generating module 21 has a plurality of first direction detection beam generators 212 disposed along a first direction L1, a plurality of second direction detection beam generators 213 disposed along a second direction L2, a plurality of third direction detection beam generators 214 disposed along a third direction L3, and a plurality of fourth direction detection beam generators 215 disposed along a fourth direction L4. The first direction L1 and the second direction L2 are directions opposite to each other; the third direction L3 and the fourth direction L4 are directions opposite to each other; and the first direction L1 and the second direction L2 are perpendicular to the third direction L3 and the fourth direction L4. If the detection beam generating module 21 is disposed in a way that the light emission surface 211 is parallel to the earth surface, the first direction L1 is the direction toward east, the second direction L2 is the direction toward west, the third direction L3 is the direction towards south, and the fourth direction L4 is the direction towards north. However, the instant disclosure is not limited thereto.

For example, in FIG. 3, the light emission surface 211 comprises four first direction detection beam generators 212 arranged along the first direction L1, four second direction detection beam generators 213 arranged along the second direction L2, four third direction detection beam generators 214 arranged along the third direction L3, and four fourth direction detection beam generators 215 arranged along the fourth direction L4. In other words, when the detection beam generating module 21 is disposed in a way that the light emission surface 211 is parallel to the earth surface, the east-west direction of the light emission surface 211 and the south-north direction of the light emission surface 211 each has eight detection light beam generators. In the embodiments of the instant disclosure, the first direction detection beam generators 212, the second direction detection beam generators 213, the third direction detection beam generators 214 and the fourth direction detection beam generators 215 are infrared light-emitting diodes. The detection beam S generated by the first direction detection beam generator 212 can stimulate the light generated by the light emission unit 31 (which is an infrared diode) and reflected by the gray card 11.

During performing the testing procedure of the motion sensor 3, the control module 22 controls one of the first direction detection beam generators 212, the second direction detection beam generators 213, the third direction detection beam generators 214 and the fourth direction detection beam generators 215 of the detection beam generating module 21 to project the detection beam S onto the optical sensing unit 32 at different timings. In other words, under a specific timing, only one detection beam S is generated by the detection beam generating module 21. The detection beam S is an infrared light beam.

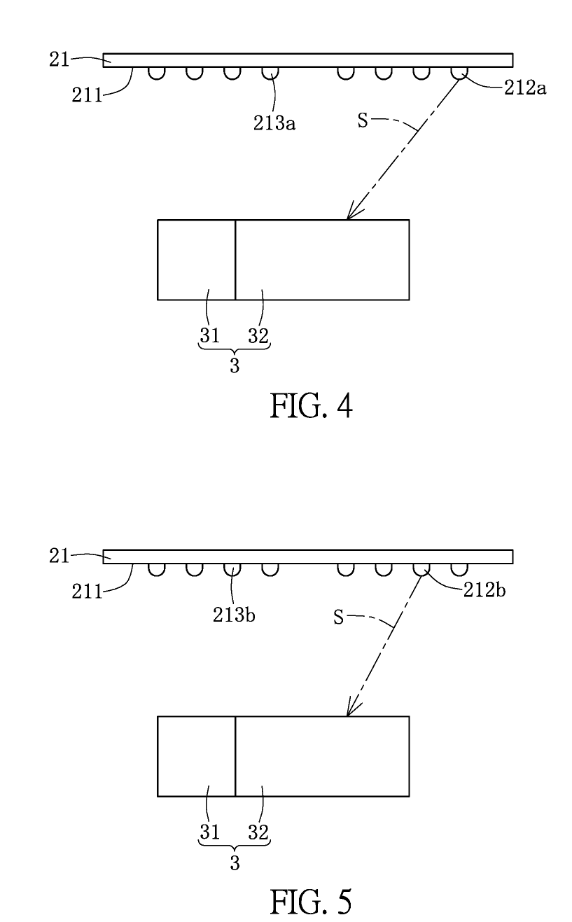

Please refer to FIG. 3 to FIG. 5. FIG. 4 and FIG. 5 are the sectional views of the detection light beam generation module and the motion sensor provided by the embodiments of the instant disclosure under two continuous timings taken along the first direction L1 and the second direction L2. As shown in FIG. 3, the control module 22 controls the first direction detection beam generator 212a of the first direction detection beam generator 212 which is nearest to the outer side of the detection beam generating module 21 to project the detection beam S onto the optical sensing unit 32 under the first timing.

Next, under the second timing (as shown in FIG. 4), the control module 22 controls the first direction detection beam generator 212b of the first direction detection beam generator 212 which is second nearest to the outer side of the detection beam generating module 21 (which is also adjacent to the first direction detection beam generator 212a generating the detection beam S under the first timing) to project the detection beam S onto the optical sensing unit 32 under the second timing. Under the next timing the control module 22 sequentially controls other first direction detection beam generators 212 to generate the detection beam S.

Please refer to FIG. 3 at the same time. After the plurality of first direction detection beam generators 212 generate the detection beam S sequentially, the control module 22 controls the second direction detection beam generator 213a of the second direction detection beam generators 213 which is nearest to the center of the detection beam generating module 21 to generate the detection beam S projecting onto the optical sensing unit 32. Next, the control module 22 controls the second direction detection beam generator 213b of the second direction detection beam generators 213 which is second nearest to the center of the detection beam generating module 21 to generate the detection beam S projecting onto the optical sensing unit 32. Under the following timings, the control module 22 continues to control other second direction detection beam generators 213 to generate the detection beam S sequentially.

As described above, the detection beam generating module 21 of the instant disclosure can stimulate the light source generated by moving the grey card above the motion sensor 3 towards the second direction L2. Similarly, by controlling the second direction detection beam generators 213 and the first direction detection beam generators 212 to sequentially generate the detection beam S in an opposite order, the light source generated by moving the grey card above the motion sensor 3 towards the first direction L1 can be stimulated.

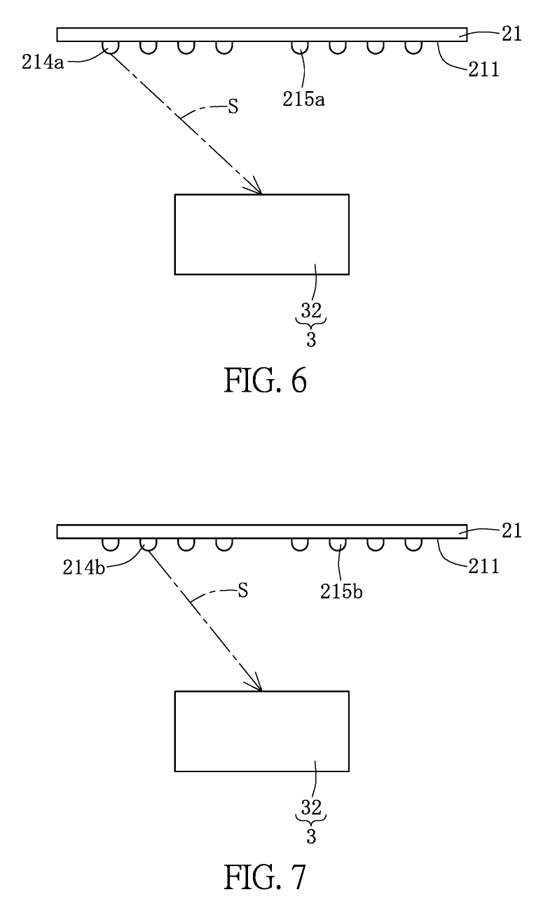

Next, please refer to FIG. 6 and FIG. 7. Please refer to FIG. 3 as needed. FIG. 6 and FIG. 7 are sectional views of the detection beam generation module of the motion sensor testing system and the motion sensor provided by the embodiment of the instant disclosure under two continuous timings. Under the third timing (as shown in FIG. 6), the control module 22 controls the third direction detection beam generator 214a of the plurality of third direction detection beam generators 214 which is nearest to the outer side of the detection beam generating module 21 to generate the detection beam S projected onto the optical sensing unit 32. In the embodiments of the instant disclosure, the third timing and the second timing are not continuous timings.

Next, in the fourth timing (as shown in FIG. 7), the control module 22 controls the third direction detection beam generator 214b of the plurality of first direction detection beam generators 212 which is second nearest to the outer side of the detection beam generating module 21 (which is also adjacent to the third direction detection beam generator 214a generating the detection beam S under the third timing) to generate the detection beam S projected onto the optical sensing unit 32. And so on, under the following timings, the control module 22 continues to control other third direction detection beam generators 214 to generate the detection beam S sequentially.

Similarly, after the plurality of third direction detection beam generators 214 generate the detection beam S sequentially, the control module 22 controls the fourth direction detection beam generator 215a of the plurality of fourth direction detection beam generators 215 which is nearest the center of the detection beam generating module 21 to generate the detection beam S projected onto the optical sensing unit 32. Next, the control module 22 controls the fourth direction detection beam generator 215b of the plurality of fourth direction detection beam generators 215 which is second nearest to the center of the detection beam generating module 21 to generate the detection beam S projected onto the optical sensing unit 32. And so on, under the following timings, the control module 22 continues to control other fourth direction detection beam generators 215 to generate the detection beam S sequentially.

As described above, the detection beam generating module 21 of the instant disclosure can stimulate the light source generated by moving the grey card above the motion sensor 3 towards the fourth direction L4. Similarly, by controlling the fourth direction detection beam generators 215 and the third direction detection beam generators 214 to sequentially generate the detection beam S in an opposite order, the light source generated by moving the grey card above the motion sensor 3 towards the third direction L3 can be stimulated.

In sum, by employing the control module 22 to control the schedule of the detection beam generating module 21 to intermittently project the detection beam S onto the optical sensing unit 32, the motion sensor testing system 2 of the instant disclosure can stimulate the testing effect achieved by the grey card 11 of the existing 3 in 1 tester. In other words, under a timing, only one of the plurality of first direction detection beam generators 212, the plurality of second direction detection beam generators 213, the plurality of third direction detection beam generators 214 and the plurality of fourth direction detection beam generators 215 generates the detection beam S projected onto the optical sensing unit 32 of the motion sensor 3. Therefore, the instant disclosure can stimulate the light beam projected onto the optical sensing unit 32 by the reflection of the grey card 11 of the detecting device 1 disposed at different positions above the motion sensor 3.

In addition, in order to stimulate the actual sensing mode during the application of the motion sensor 3 more accurately, the intensity of the detection beam S can be controlled by the control module 22. Specifically, the detection beam generating module 21 can be calibrated by the control module 22, thereby allowing the plurality of first direction detection beam generators 212, the plurality of second direction detection beam generators 213, the plurality of third direction detection beam generators 214 and the plurality of fourth direction detection beam generators 215 in the detection beam generating module 21 generating the detection beam S with the same or different intensities. Please refer to FIG. 4. Taking the first direction L1 as an example, the plurality of first direction detection beam generators 212 can generate the detection beam S with different intensities under different timings.

Specifically, the calibrating process described above comprises disposing the gray card 11 (or an object) for conducting the testing procedure in the existing art at a fixed location above the motion sensor 3 for a distance of about 2 to 4 centimeters, emitting a light beam onto the surface of the gray card 11 by the detecting device 1, and receiving the optical signal of the light beam reflected by the surface of the gray card 11 by the optical sensing unit 32. Next, the gray card 11 is removed and substituted by the detection beam generating module 21. The detection beam generating module 21 is disposed at another fixed location above the motion sensor 3 for a distance of about 8 to 10 centimeters. According to the optical signal received by the detection beam generating module 21, the intensity (of brightness) of the detection beam S generated by the detection beam generating module 21 is adjusted by the control module 22, thereby stimulating the effect resulting from the detection beam generating module 21 in the existing art.

During the procedure of intermittently projecting the detection beam S by the plurality of first direction detection beam generators 212, the plurality of second direction detection beam generators 213, the plurality of third direction detection beam generators 214 and the plurality of fourth direction detection beam generators 215 of the detection beam generating module 21, the optical signal of the detection beam S projected onto the optical sensing unit 32 is stored by the control module 22 and transmitted to the processor module 23 for calculation, thereby obtaining a detecting result. The processor module 23 can be a microprocessor.

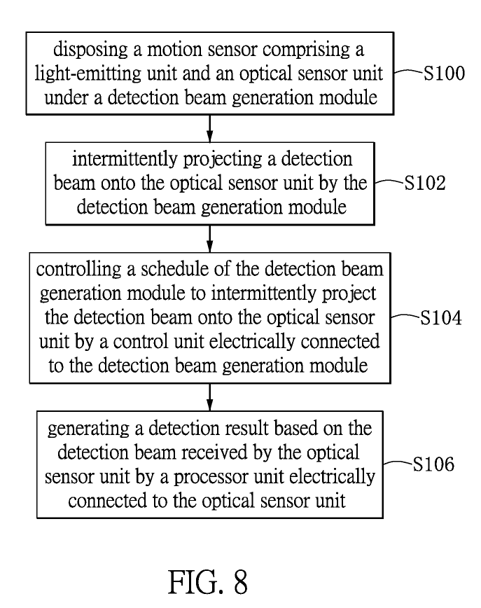

Please refer to FIG. 8. The instant disclosure further provides a method for testing a motion sensor. The steps comprised in the method for testing a motion sensor are described in the following paragraphs.

First, disposing a motion sensor 3 comprising a light-emitting unit 31 and an optical sensor unit 32 under a detection beam generation module 21 (step (a), referred to as the step S100 in FIG. 8). The detection beam generating module 21 has a light emission surface 211, and the light emission surface 211 facing the optical sensing unit 32 of the motion sensor 3. The distance between the light emission surface 211 and the optical sensing unit 32 can be 2 to 5 centimeters. However, the instant disclosure is not limited thereto.

The light emission surface 211 comprises a plurality of first direction detection beam generators 212 arranged along a first direction L1, a plurality of second direction detection beam generators 213 arranged along a second direction L2, a plurality of third direction detection beam generators 214 arranged along a third direction L3 and a plurality of fourth direction detection beam generators 215 arranged along a fourth direction L4. The first direction L1 and the second direction L2 are two directions opposite to each other, the third direction L3 and the fourth direction L4 are two directions opposite to each other, and the first direction L1 and the second direction L2 are perpendicular to the third direction L3 and the fourth direction L4.

Next, the detection beam generating module 21 intermittently projects a detection beam S onto the optical sensing unit 32 (step (b), referred to as the step S102 in FIG. 8), and controls a schedule of the detection beam generation module 21 to intermittently project the detection beam S onto the optical sensor unit 32 by a control unit 22 electrically connected to the detection beam generation module 21 (step (c), referred to as the step S104 in FIG. 8). The details of intermittently projecting the detection beam S onto the optical sensing unit 32 by the detection beam generating module 21 are similar to that described regarding the motion sensor testing system 2 (particularly to the operation of the control module 22) and are not described again.

Next, generating a detection result based on the detection beam S received by the optical sensor unit 32 by a processor unit 23 electrically connected to the optical sensor unit 32 (step (c), referred to as the step S106 in FIG. 8). The details of employing the processor module 23 to calculate the detection result are similar to that described regarding the motion sensor testing system 2 and are not described again.

In summary, the advantage of the instant disclosure resides in that the motion sensor testing system 2 and the method using the same provided by the embodiments of the instant disclosure can reduce the complexity and the testing time of the testing process through the technical feature of “the detection beam generating module 21 disposed above the motion sensor 3, the detection beam generating module 21 intermittently projects a detection beam S onto the optical sensing unit 32”, and “disposing a motion sensor 3 comprising a light-emitting unit 31 and an optical sensor unit 32 under a detection beam generation module 21 . . . intermittently projecting a detection beam S onto the optical sensor unit 32 by the detection beam generation module 21”.

Specifically, by the use of the detection beam generating module 21, the motion sensor 3 does not have to use the light emission unit 31 thereof to generate a light, and the need of the gray card 11 is eliminated. Therefore, the testing system does not have to comprise a driving module 13 for driving the gray card 11. Compared to the 3 in 1 tester in the existing art, the motion sensor testing system 2 of the instant disclosure has an improved structural complexity and operation procedure. For example, the existing 3 in 1 tester takes 9 to 10 seconds to complete the testing process, and the system of the instant disclosure only takes about 5 seconds. In other words, the motion sensor testing system 2 and the method using the same provided by the instant disclosure reduce the testing time by about 50%.

In addition, since the device for testing an ambient light sensor in the existing 3 in 1 tester comprises a light source plate, the motion sensor testing system 2 provided by the instant disclosure can integrate the detection beam generating module 21 with the light source plate, thereby further reducing the manufacturing cost and maintaining cost of the testing system.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A motion sensor testing system for detecting a motion sensor, the motion sensor comprises a light-emitting unit and an optical sensor unit, the motion sensor testing system comprising:
a detection beam generation module disposed above the motion sensor, wherein the detection beam generation module intermittently projects a detection beam onto the optical sensor unit;
a control module electrically connected to the detection beam generation module for controlling the detection beam generation module to intermittently project the detection beam onto the optical sensor module; and
a processor module electrically connected to the optical sensor unit, wherein the processor module generates a detection result according to the detection beam received by the optical sensor unit;
wherein the detection beam generation module comprises a plurality of first direction detection beam generators arranged along a first direction, a plurality of second direction detection beam generators arranged along a second direction, a plurality of third direction detection beam generators arranged along a third direction and a plurality of fourth direction detection beam generators arranged along a fourth direction, the first direction and the second direction being opposite to each other, the third direction and the fourth direction being opposite to each other, and the first direction and the second direction being perpendicular to the third direction and the fourth direction;
wherein the first direction detection beam generators, the second direction detection beam generators, the third direction detection beam generators and the fourth direction beam generators intermittently project a first detection beam, a second detection beam, a third detection beam and a fourth detection beam onto the optical sensor unit respectively.

2. The motion sensor testing system according to claim 1, wherein the control module is configured to control a schedule of the first direction detection beam generators, the second direction detection beam generators, the third direction detection beam generators and the fourth direction detection beam generators for projecting the first detection beam, the second detection beam, the third detection beam and the fourth detection beam onto the optical sensor unit respectively.

3. The motion sensor testing system according to claim 1, wherein the light-emitting unit is an infrared light-emitting diode, and the first direction detection beam generators, the second direction detection beam generators, the third direction detection generator and the fourth direction detection beam generators are infrared light-emitting components.

4. The motion sensor testing system according to claim 1, wherein the control module electrically connects to the detection beam generation module for controlling an intensity of the detection beam.

5. A method for testing a motion sensor, comprising the following steps:
(a) disposing a motion sensor comprising a light-emitting unit and an optical sensor unit under a detection beam generation module;
(b) intermittently projecting a detection beam onto the optical sensor unit by the detection beam generation module;
(c) controlling a schedule of the detection beam generation module to intermittently project the detection beam onto the optical sensor unit by a control unit electrically connected to the detection beam generation module; and
(d) generating a detection result based on the detection beam received by the optical sensor unit by a processor unit electrically connected to the optical sensor unit;
wherein the detection beam generation module comprises a plurality of first direction detection beam generators arranged along a first direction, a plurality of second direction detection beam generators arranged along a second direction, a plurality of third direction detection beam generators arranged along a third direction and a plurality of fourth direction detection beam generators arranged along a fourth direction, the first direction and the second direction being opposite to each other, the third direction and the fourth direction being opposite to each other, and the first direction and the second direction being perpendicular to the third direction and the fourth direction;
wherein the first direction detection beam generators, the second direction detection beam generators, the third direction detection beam generators and the fourth direction beam generators intermittently project a first detection beam, a second detection beam, a third detection beam and a fourth detection beam onto the optical sensor unit respectively.

6. The method according to claim 5, wherein the control module controls a schedule of the first direction detection beam generators, the second direction detection beam generators, the third direction detection beam generators and the fourth direction detection beam generators for projecting the first detection beam, the second detection beam, the third detection beam and the fourth detection beam onto the optical sensor unit respectively.

7. The method according to claim 5, wherein the control module is electrically connected to the detection beam generation module for controlling an intensity of the detection beam.
